(19) United States
(12) Patent Application Publication
(10) Pub. No.: US 2008/0105995 A1
(43) Pub. Date: May 8, 2008

(54) Method and apparatus for making spiral separators

(75) Inventor: Thomas J. Grey, Jacksonville, FL (US)

Correspondence Address: ARTHUR G. YEAGER, P.A., 245-1 EAST ADAMS STREET, JACKSONVILLE, FL, 32202-3336, US

(73) Assignee: Outokumpu Technology Oyj a public limited company of Finland

(21) Appl. No.: 11/594,682

(22) Filed: Nov. 8, 2006

(51) Int. Cl. B29C 39/38; B29C 39/02

(52) U.S. Cl. 264/109

(57) ABSTRACT

An aluminum mold for the interior surfaces of one or more spirals is rotated at a temperature sufficient to melt a weldable plastic such as LLDP or HDP plastic in a predetermined amount sprinkled thereon. Plastic powder not melted is recovered and redeposited until all the plastic powder is melted. The mold or molds are then cooled and the formed spiral is removed.

### CROSS-REFERENCE TO RELATED APPLICATION

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention relates to plastic molding techniques and apparatus and particularly to methods and apparatus for molding plastic spiral turns used in spiral separators.

2. Related Art

Many techniques exist for molding plastic parts. A well known technique for manufacturing plastic parts is called roto-molding, which works as follows: a thin walled, hollow metal mold is created for a ball, for example. The mold has a cavity that is shaped like a ball and the mold can be opened in half like a clamshell. A measured amount of powdered thermoplastic material, like HDPE (High Density Polyethylene) or LLDPE (Linear Low Density Polyethylene) is put inside the mold and the mold is closed. The mold is then rotated (two axis) inside an oven. As the mold is heated and rotated the powder begins to melt and cling to the inside of the cavity and this occurs until all of the powder is melted. The mold is then cooled and opened. One then extracts a molded, hollow ball made of plastic. More complex parts can be made with additional complexity in the molds. This method is used for making children's toys, agricultural liquid tanks, barrels, drums and many other commercial, industrial and consumer items cheaply and efficiently and in a semi-automated way.

The problems with rotomolding a spiral are substantial and mostly come form the need to de-mold the part after it is made. A 2-piece mold has been made for a 180° segment of a spiral and have (plastic) welded 14 of these segments together to prove that a 7-turn, plastic spiral will work just like a 7-turn, polyurethane/fiberglass spiral will. However, a mold for a full sized, 7-turn spiral would be extremely costly and have significant risk because it would necessarily be at least a 21-piece mold. This would be difficult to use, be prone to damage during handling, and create a criss-cross of witness lines (where the mold parts come together) that would have to be cleaned up by hand.

An existing method for manufacturing a spiral for minerals separation is as follows: A manufacturer creates a spiral shape out of fiberglass for testing by manual and semi-manual means. Once the test spiral is approved, the manufacturer takes an impression of the approved spiral using gel-coated fiberglass. The approved spiral is called the plug in this manufacturing technology and the impression is called the mold. This mold is made from gel-coat with a fiberglass substrate. To make a spiral from this mold, one first treats the gel-coat surface with a mold release agent. Then polyurethane is sprayed onto the gel-coat surface to a thickness of about 3 to 5 mm. When this hardens, layers of resin and fiberglass mat are laid over the polyurethane to a thickness of about 5 to 10 mm. Once these layers harden, the spiral is loosened from the mold surface by prying. Once the entire spiral is loose, then the spiral can be unwound or unscrewed out of the mold. In general these spirals are 5 to 7 turns long and look almost like a coil spring. The spiral is trimmed, fitted with accessories like feed boxes, discharge boxes, splitters and a center column for support. Improvements are needed in molding spiral separators.

### BRIEF SUMMARY OF THE INVENTION

In one aspect of the present invention there is provided a method for making a spiral for use in spiral separators comprising the steps of: forming a mold for molding the interior surfaces of a spiral which is adapted for use as a spiral separator; selecting a plastic powder to be molded into a spiral; heating the mold to a predetermined temperature sufficient to melt the selected powder; depositing the powder onto the heated mold; melting the powder deposited onto the mold; lowering the temperature of the mold below the melting point of the powder; and removing the formed spiral from the mold.

Additional steps include: forming the mold of aluminum; selecting linear low density polyethylene; heating the mold to a temperature of 325-375° F.; alternately selecting high density polyethylene; sprinkling the plastic powder onto the mold; and rotating the heated mold around the centerline axis of the spiral being molded.

Other steps include: collecting sprinkled powder that does not attach to the mold; resprinkling the powder collected onto the mold; selecting a predetermined amount of the selected plastic powder; repeating the steps until all the plastic powder selected is melted onto the mold; selecting a material that can be plastic welded after the spiral is molded and attaching a plurality of heating elements to the mold spaced away from the mold surface receiving the powder to be melted.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a pictorial block diagram of the apparatus in accord with the present invention;

FIG. 2 is a front elevation view of the control panel in FIG. 1;

FIG. 3 is a rear view of the mold illustrating the heaters of FIG. 1;

FIG. 4 is a perspective view of a spiral formed on a mold in accord with the present invention;

FIG. 5 is a perspective view of a completed spiral; and

FIG. 6 is a perspective view of a completed spiral.

### DETAILED DESCRIPTION OF THE INVENTION

### Introduction

The invention is a new method for manufacturing spirals out of polyethylene like LLPDE, Linear Low Density Polyethylene and HDPE, High Density Polyethylene or any other thermoplastic material. As used herein, the term spiral refers to an entire spiral of perhaps 1-7 spiral turns, as well as a partial spiral turn of about 90°-360°. The new method of manufacturing spirals will use an open mold that is similar to a mold used currently to make polyurethane lined fiberglass spirals. The mold will also have similarities to a roto-mold that is currently used to make hollow plastic parts for consumer, commercial and industrial applications in that it is made of aluminum for good heat transfer. There are several advantages of using this new method, not the least of which include low material cost and low raw spiral cost. Additionally, the new method offers both the ability to automate the manufacturing process, and rapidly make new molds anywhere in the world. This method is also much more environmentally friendly than the current polyurethane-fiberglass method.

The spiral mold process in accord with the present invention is an open mold, unlike a closed roto-mold, and more like the conventional mold used for making polyurethane/fiberglass spirals. The biggest differences are (1) the mold is aluminum instead of fiberglass and (2) the mold will be heated by electric cartridge or strip heaters that will be controlled to create the ideal conditions to melt powdered plastic. The heaters are mounted on or in the backside of the mold leaving the front side available to accept the melting plastic. The mold is heated to the proper temperature (325° to 375° F. depending on the plastic chosen) to melt the powdered plastic. The plastic powder is then sprinkled onto the heated mold while the mold is rotated around the centerline axis of the spiral. The powder that does not melt on the mold falls below and is collected and re-introduced at the top. A system is provided to store a pre-weighed charge of plastic powder, feed it to the sprinkler, collect it after falling and reintroduce it until all of the powder is melted on the mold. When the powder is completely melted, the temperature of the heated mold is lowered for spiral removal. The spiral part is pried off of the mold until it is freed, then the spiral part is unwound or unscrewed from the mold. Except for de-molding, the entire process can be completely automated.

### Apparatus

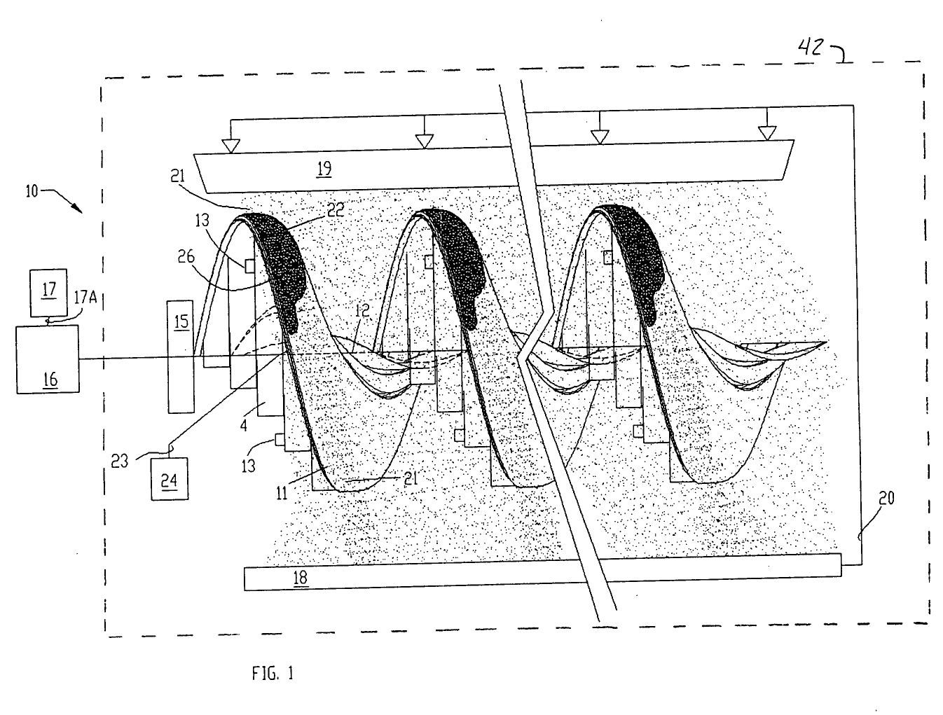

With respect now to the drawings, a block diagram of the molding system in accord with the present invention is shown in FIG. 1 at numeral 10. The present description is directed to one or more turns of a spiral separator, preferably 5 to 7 turns with 3 turns being shown in FIG. 1. Each turn, regardless of size, pitch, etc., is formed in the same manner.

An aluminum mold 11 is made to provide the interior operating surfaces of the desired number of molded spiral turns. Mold 11 is rotatable about the centerline axis 12 by way of drive mechanism 23 driven by motor 24.

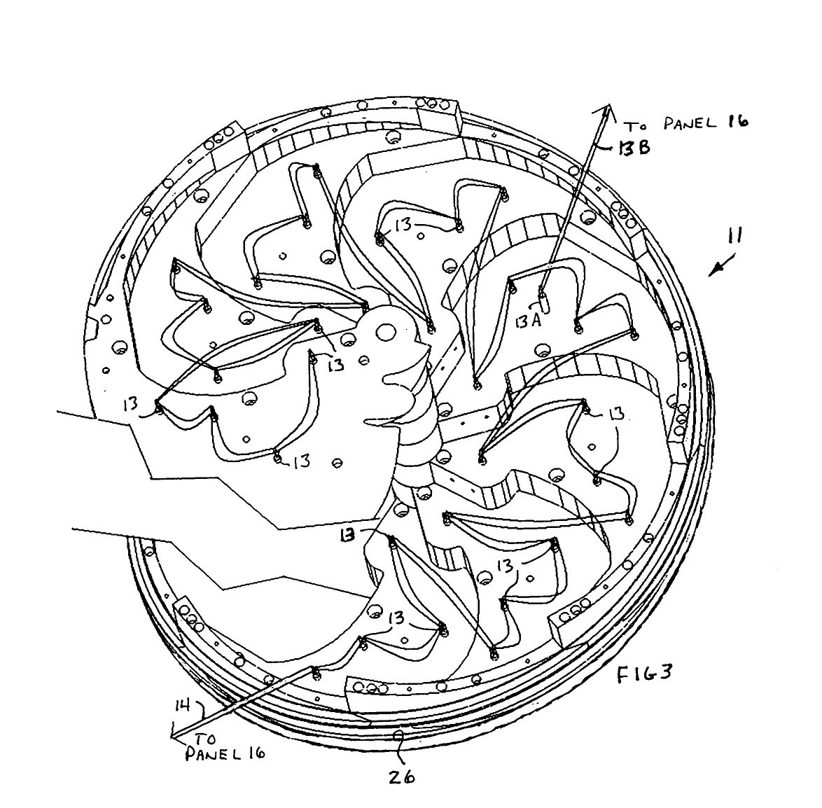

Mold 11 is heated via a plurality of spaced heaters 13 (only a few numbered for ease of illustration) that may be embedded in the rear portion 34 of mold 11 and connected via rotatable wiring harness 15 by power lines 14 shown in FIG. 3. A control panel 16 controls electric power from power supply 17 connected at point 17A. Thermocouple 13A provides data via wire 13B for controlling the temperature of the heaters 13.

Plastic powder 21 of a selected type and of a predetermined amount is deposited on mold 11 via dropping from trough or sprinkler 19 that is recharged with powder 21 that does not stick to the heated mold via powder collector 18 and return-to-top conveyance apparatus 20 which may be pneumatic or mechanical as desired. Molten plastic powder 22 attaches to mold 11 for the formation of a partially formed spiral 26. Blowers may be used in lieu of sprinkler 19 since the invention includes an enclosure or cabinet 42.

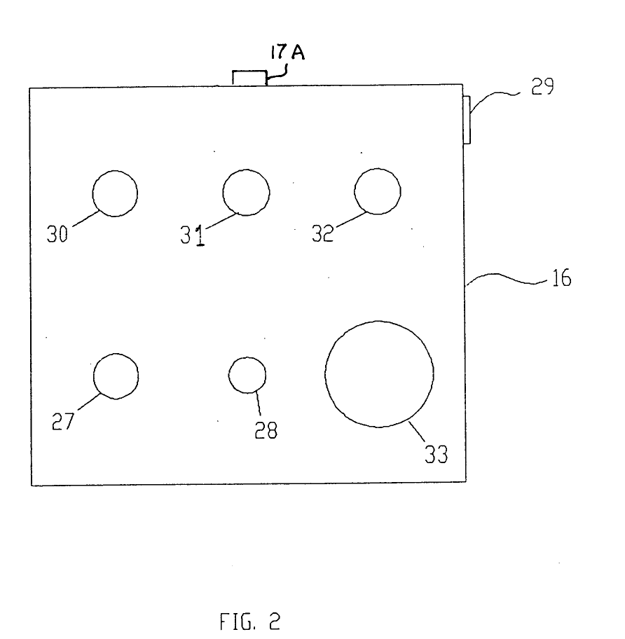

FIG. 2 illustrates the control panel 16 and the emergency stop switch 27, power indication light 28, key lock 29, control knob 33 and other switches 30, 31, 32 as well known in the art.

The specific number and spacing of heaters 13 (FIG. 3) is determined by the type of plastic powder 21 used as well as by other factors as understood in the art.

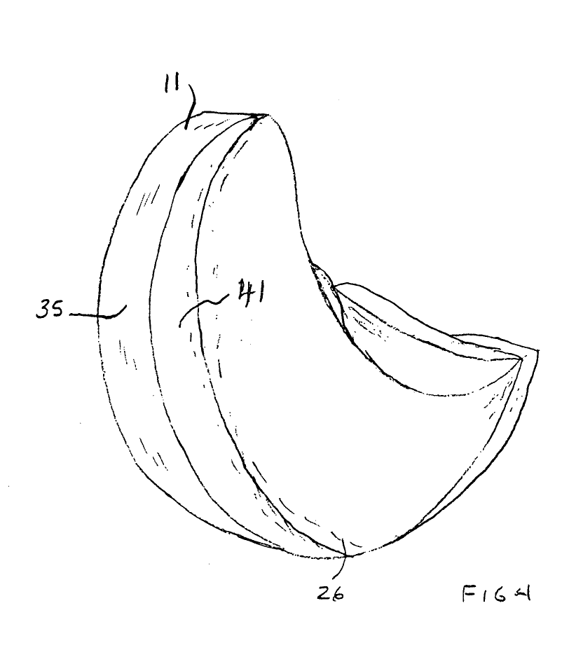

FIG. 4 illustrates front portion 35 of mold 11 that is shaped to provide the desired inner surface shape of each completed spiral 26.

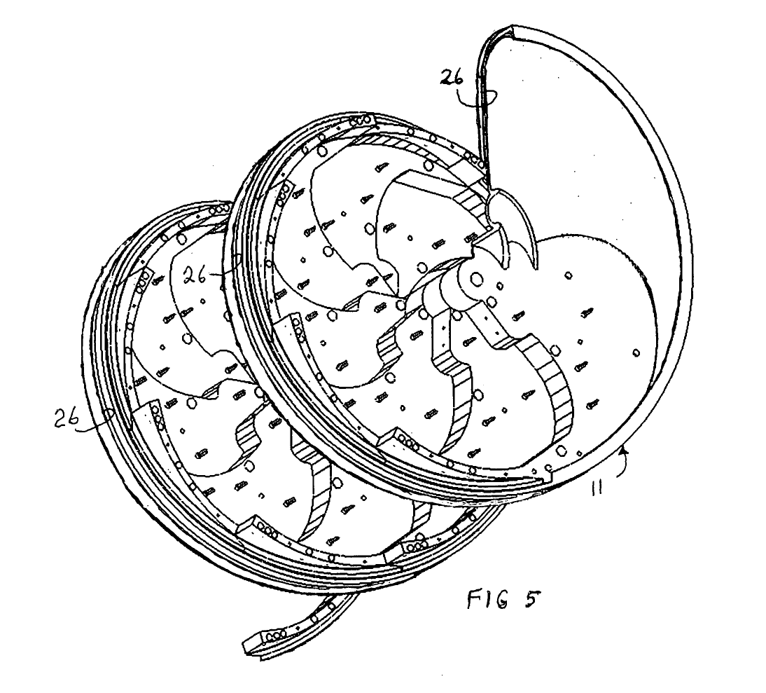

FIG. 5 illustrates a partial molded spiral 26.

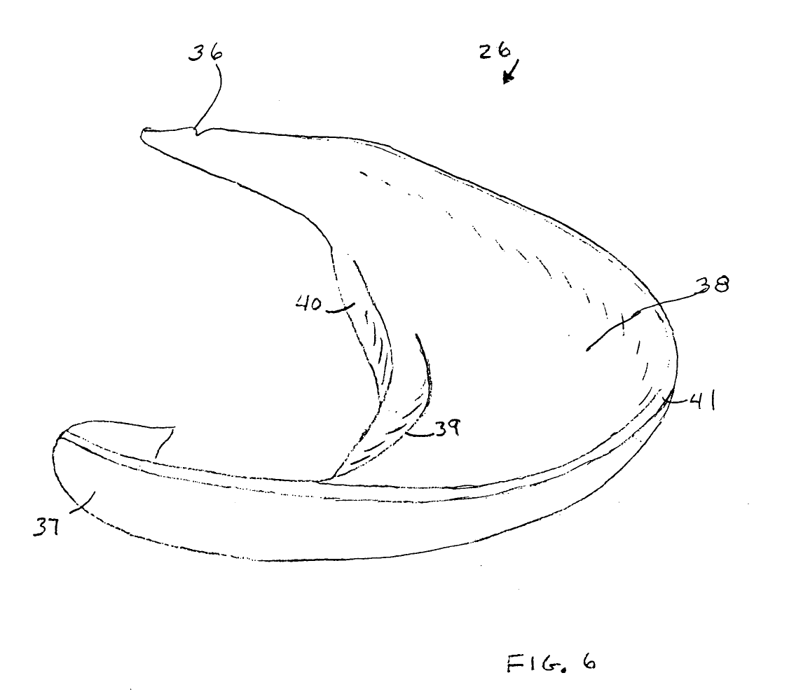

FIG. 6 illustrates a completed molded spiral 26. Inlet portion 36 and outlet portion 37 support central tray portion 38, interior channel portion 39, outside flange portion 40, and tray wall 41 are all formed for the use of the spiral separator (not shown) that will include 5-7 completed and trimmed spirals 26 in many applications.

### Methodology

The method of forming one or more spiral turns 16 is as follows:
A. forming a mold 11 of the appropriate material, preferably aluminum;
B. heating the mold 11 to a predetermined temperature appropriate to melt the plastic powder 21 that will be used, preferably to 325-375° F.;
C. selecting a plastic powder that can be plastic welded, preferably linear low density polyethylene (LLDPE) or high density polyethylene (HDPE) to be molded into each spiral turn;
D. selecting a predetermined amount of powder in step C;
E. depositing the powder by sprinkling the powder of step C downwardly (or otherwise such as sideways or upwardly) onto the mold of step A, heated in step B for melting the powder onto the mold;
F. rotating the heated mold around the centerline axis of the mold for forming each spiral;
G. collecting powder sprinkled in step E that does not attach to the mold;
H. sprinkling the powder collected in step G onto the mold of step A;
I. repeating steps E-H until substantially all the powder selected in step D has been melted onto the mold thereby forming the spiral;
J. lowering the temperature of the mold; and
K. removing the completed spiral from the mold.

Preferably, the mold 11 is attached to a plurality of molds 11 for a total of 5-7 turns to create a spiral to which other structural members such as feed boxes, discharge boxes, splitters and any desired or necessary support elements for the spiral separator to be constructed and used. Such other members may be molded with a spiral in whole or in part in some applications.

There are many advantages to the present approach to spiral manufacture including:

Cost of materials for each spiral is dramatically reduced.

There are significant environmental advantages for thermoplastics over the resins currently used for the polyurethane/fiberglass method.

The thermoplastics are readily available throughout the world.

Spirals could be created using several different plastics layered one upon the other to make the spiral more operator friendly by repeating steps B-I as appropriate. For Example: The first could be a wear layer like LLDPE, Linear Low Density Polyethylene. The second could be a wear layer of a different color and the third could be a structural layer like HDPE, High Density Polyethylene. The intermediate different colored wear layer would provide an indicator that the spiral is about to wear through and would give the user an opportunity to get ready to change out the spiral before it actually wears through and causes a mess and a possible unscheduled shut-down. In addition, logos and markings can be easily applied during or after the molding process.

Importantly, these plastic materials can normally be fabricated and repaired by welding. Accessories that cannot be molded could be attached later by plastic welding. These items may include feed boxes, discharge boxes and splitter handle retainers. The polyurethane of the conventional spiral cannot be repaired or welded.

Preferably, the rotating mold 11 and the associated conveyor/sprinkler apparatus is housed in an enclosure or cabinet 42 to keep the selected powder therein and to keep dirt and moisture away from the molding system. In addition, air can be heated, cooled and dried to control the molding as desired in the circumstances.

While the invention has been described with respect to certain specific embodiments, it will be appreciated that many modifications and changes may be made by those skilled in the art without departing from the spirit of the invention. It is intended therefore, by the appended claims to cover all such modifications and changes as fall within the true spirit and scope of the invention.

What is claimed as new and what it is desired to secure by Letters Patent of the United States is:

1. A method for making a spiral for use in spiral separators comprising the steps of:
(a) forming a mold for a spiral;
(b) selecting a plastic powder to be molded into a spiral;
(c) heating the mold to a predetermined temperature sufficient to melt the selected powder of step (b);
(d) depositing the powder of step (b) onto the mold heated in step (c);
(e) melting the powder deposited in step (d) onto the mold;
(f) lowering the temperature of the mold below the melting point of the powder; and
(g) removing the formed spiral from the mold.

2. The method of claim 1 wherein step (a) includes the step of:
(h) forming the mold of aluminum.

3. The method of claim 1 wherein step (b) includes the step of:
(h) selecting linear low density polyethylene.

4. The method of claim 3 wherein step (c) includes the step of:
(h) heating the mold to a temperature of 325-375° F.

5. The method of claim 1 wherein step (b) includes the step of:
(h) selecting high density polyethylene.

6. The method of claim 5 wherein step (c) includes the step of:
(i) heating the mold to a temperature of 325-375° F.

7. The method of claim 1 wherein step (d) includes the step of:
(h) sprinkling the plastic powder onto the mold.

8. The method of claim 1 further including the step of:
(i) rotating the heated mold.

9. The method of claim 8 wherein step (i) includes rotating the heated mold around the centerline axis of the spiral being molded.

10. The method of claim 7 further including the steps of:
(i) collecting sprinkled powder that does not attach to the mold; and
(j) resprinkling the powder collected in step (i) onto the mold.

11. The method of claim 10 further including the step of:
(k) selecting a predetermined amount of the selected plastic powder of step b.

12. The method of claim 11 further including the step of:
(i) repeating steps (i) and (j) until all the plastic powder selected in step (k) is melted onto the mold.

13. The method of claim 1 wherein step (b) includes the step of:
(h) selecting a material that can be plastic welded after the spiral is molded.

14. The method of claim 1 wherein step (c) includes the step of:
(h) attaching a plurality of heating elements to the mold of step (a) spaced away from the mold surface receiving the powder to be melted.

15. The method of claim 1 further including the steps of:
(h) collecting deposited powder that does not attach to the mold in step (d); and
(i) redepositing the powder collected in step (h) onto the mold.

16. The method of claim 1 further including the steps of:
(h) selecting a predetermined amount of the selected plastic powder of step (b);
(i) collecting powder that does not attach and melt on the mold;
(j) resprinkling the powder collected in step (i) onto the mold; and
(l) repeating steps (i) and (j) until substantially all the powder of step (h) is melted onto the mold.

17. The method of claim 1 wherein step (a) includes the step of:
(h) forming a mold for molding the interior surfaces of a spiral which is adapted for use as a spiral separator.

18. A method for making a plurality of spirals for use in spiral separators comprising the steps of:
(a) forming a mold for each spiral;
(b) selecting a plastic powder to be molded into each spiral;
(c) heating each mold to a predetermined temperature sufficient to melt the selected powder of step (b);
(d) depositing the powder of step (b) onto each mold heated in step (c);
(e) melting the powder deposited in step (d) onto each mold;
(f) lowering the temperature of each mold below the melting point of the powder; and
(g) removing the formed spirals from each mold.

19. The method of claim 18 wherein step (b) includes the steps of:
(h) selecting either linear low density polyethylene or high density polyethylene; and
(i) heating the mold to a temperature of 325-375° F.

20. The method of claim 19 wherein step (d) includes the steps of:
(j) rotating the heated mold around the centerline axis of the spiral being molded;
(k) selecting a predetermined amount of the selected plastic powder in step b;
(l) collecting sprinkled powder that does not attach to each mold;
(m) resprinkling the powder collected in step (k) onto each mold; and
(n) repeating steps (l) and (m) until all the plastic powder selected in step k is melted onto each mold.
